(19) United States
(12) Patent Application Publication
(10) Pub. No.: US 2026/0170098 A1
(43) Pub. Date: Jun. 18, 2026

(54) PROCESSOR SECURITY ARCHITECTURE FOR DIGITAL RIGHTS MANAGEMENT

(71) Applicants: ADVANCED MICRO DEVICES, INC., Santa Clara, CA (US); ATI TECHNOLOGIES ULC, MARKHAM (CA)

(72) Inventors: Kaushal Amolak Sanghai, Boxborough, MA (US); Lu Lu, Beijing (CN); Kathirkamanathan Nadarajah, Markham (CA); Anthony Asaro, Markham (CA)

(21) Appl. No.: 18/985,695

(22) Filed: Dec. 18, 2024

(51) Int. Cl. G06F 21/10

(52) U.S. Cl. CPC G06F 21/107; G06F 2221/2141

(57) ABSTRACT

A processing system employs system hardware to secure different DRM channels. The processing system employs an architecture including a root-of-trust (RoT) processor that assigns different keyspaces to different DRM channels. The processing system further includes one or more security gaskets that employ the assigned keyspaces to isolate the different DRM channels from each other. The security gasket receives a transaction targeting a DRM pipeline and allows the transaction to proceed based on a keyspace identified by the transaction and a keyspace assigned to the DRM.

### BACKGROUND

Processing systems are often used to present digital content, such as entertainment content, to a user. For example, some processing systems are employed to receive one or more streams of digital content from a wide-area network, such as the Internet, and present that content to the user. Examples of such digital content include game content, video entertainment content (e.g., television shows or movies), and the like. In many cases, the digital content is owned by a content provider, rather than the user, and the content provider implements a digital rights management (DRM) scheme to protect the digital content from unauthorized copying, storage, or other access. However, conventional DRM schemes do not provide sufficient protection in many processing systems, such as processing systems that are configured to receive and present digital content from different content providers.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that supports multiple hardware-secured DRM pipes in accordance with some embodiments.

FIG. 2 is a block diagram illustrating an example of the processing system of FIG. 1 employing a root-of-trust processor to assign keyspaces to the multiple hardware-secured DRM pipes in accordance with some embodiments.

FIG. 3 is a block diagram illustrating an example of the processing system of FIG. 1 employing a hardware security gasket to secure a DRM pipe in accordance with some embodiments.

FIG. 4 is a block diagram illustrating an example of a DRM transaction message at the processing system of FIG. 1 in accordance with some embodiments.

FIG. 5 is a block diagram of a security gasket of the processing system of FIG. 1 in accordance with some embodiments.

FIG. 6 is a flow diagram of a method of employing a security gasket to support hardware-secured DRM pipes at a processing system in accordance with some embodiments.

### DETAILED DESCRIPTION

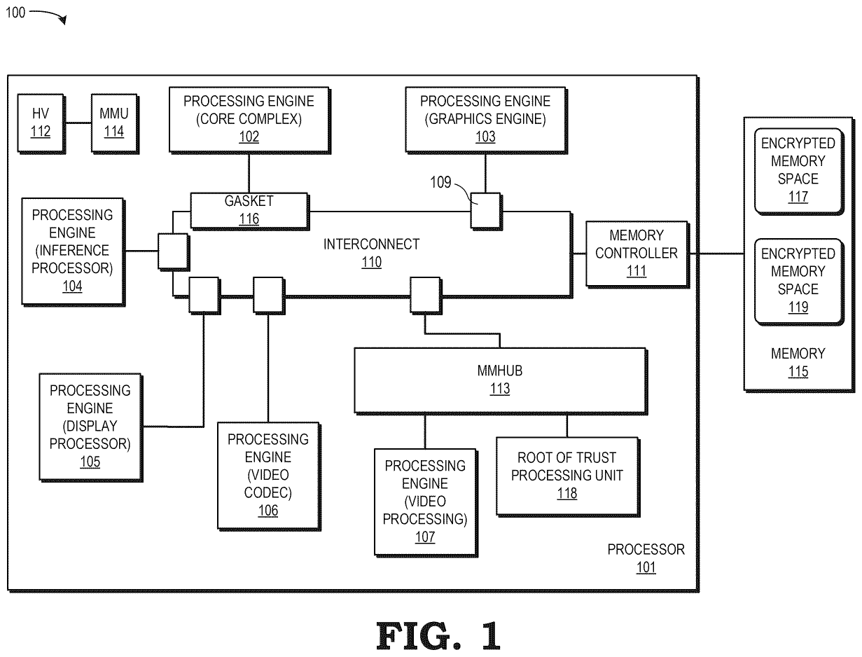

FIGS. 1-6 illustrate techniques for employing the hardware of a processing system to secure different DRM channels. The processing system employs an architecture including a root-of-trust (RoT) processor that assigns different keyspaces (e.g., address ranges) to different DRM channels. The processing system further includes one or more hardware security gaskets that employ the assigned keyspaces to isolate the different DRM channels from each other, and from any untrusted or non-DRM content. The processing system thereby provides robust, hardware-based security that protects DRM content from unauthorized access or use.

To illustrate via an example, in some embodiments a processing system includes an RoT processing unit and plurality of processing engines, such as a general-purpose processing engine (e.g., a central processing unit (CPU), an inference engine, a video codec, a graphics engine, a display engine, and the like. The processing system further includes a communication fabric that connects the processing engines and the RoT processing unit. The processing engines communicate with each other, and with other hardware of the processing system, by providing transactions to the communication fabric. The processing system is configured to support multiple DRM channels, referred to as DRM pipes, and to isolate the DRM pipes from each other. To support this hardware isolation, the processing system includes a set of hardware gaskets that govern access to the communication fabric by the processing engines, based on keyspaces assigned to the different DRM pipes.

Thus, for example, in some embodiments the RoT processing unit assigns a different keyspace to each DRM pipe, and further assigns each processing engine to one or more of the DRM pipes by providing to each processing engine the keyspaces for the processing engine's assigned DRM pipes. When a processing engine generates a transaction for a DRM pipe, the processing engine includes with the transaction 1) the DRM pipe associated with the transaction; and 2) an identifier of the key for the DRM pipe (e.g., a key index). The hardware security gasket (sometimes referred to herein as a “security gasket” for simplicity) receives the transaction and compares the key identifier indicated by the transaction with the identifier for the key assigned to the indicated DRM pipe. If the indicated key is not assigned to the indicated DRM pipe, the security gasket discards the transaction, and in particular does not provide the transaction to the indicated destination. The security gasket thereby prevents unauthorized transactions, and thus prevents unauthorized access to the DRM pipes. The processing system thus provides hardware support for DRM pipe isolation, thereby enhancing overall system security.

In some embodiments, the security gasket enforces additional security requirements for transactions, such as ensuring that physical addresses supplied by a memory management unit (MMU) are within specified parameters. For example, in some embodiments a system hypervisor or operating system sets up page tables at the MMU (e.g., a system memory management unit (SMMU) or input/output memory management unit (IOMMU)) and the MMU employs the page tables to perform address translation for each transaction, and in particular translates a virtual address for each transaction to a corresponding physical address. In addition, the RoT processing unit generates the key IDs for the different DRM pipes such that a portion of the physical address for each DRM pipe (when the physical address is properly generated) matches the key ID for the corresponding DRM pipe. For each transaction, the MMU provides the security gasket with the corresponding physical address. In response, the security gasket compares the portion of the physical address with the key ID (either as provided with the transaction or as stored at the security gasket). In response to a mismatch, the security gasket discards the transaction. The security gasket thereby protects the DRM pipes from unauthorized access via improper address translation, such as from a malicious hypervisor that sets up the page tables at the MMU in a malicious way (e.g., to direct memory requests or other transactions to incorrect physical addresses).

In some embodiments, the DRM pipes, and corresponding security characteristics are configurable to allow the processing system to tailor aspects of the different DRM pipes and thereby support a wide variety of applications and DRM approaches. For example, in some embodiments, different processing engines are assigned to a DRM pipe with different access permissions, such as different read and write permissions. This allows, for example, the processing system to support a DRM pipe that shares data among different processing engines, while allowing only a limited number of the DRM pipes to modify that data. The processing system thereby supports application flexibility for the different DRM pipes while maintaining security for DRM data.

FIG. 1 illustrates a block diagram of a processing system 100 that is generally configured to present digital data to a user in accordance with some embodiments. Examples of the digital data include image data, audio data, and the like or any combination thereof. Thus, in different embodiments, the digital data includes game data, video data (e.g., movies and television), audio data (e.g., music), and the like, or any combination thereof. Accordingly, in different embodiments, the processing system 100 is implemented, or partially implemented, in an electronic device configured to present digital data to a user, such as desktop computer, laptop computer, game console, smartphone, television, automobile, and the like.

To support presentation of digital content, the processing system 100 includes a processor 101 and a memory 115. It will be appreciated that, at least in some embodiments, the processing system 100 includes additional circuitry, not illustrated at FIG. 1, that supports presentation of digital data, such as one or more display devices, one or more input/output devices and associated controllers, one or more network interfaces, one or more power sources and associated circuitry, and the like, or any combination thereof. Turning to the circuitry illustrated at FIG. 1, the memory 115 is a set of one or more memory devices generally configured to store data on behalf of the processor 101. Thus, in the course of performing one or more aspects of the operations described herein, the processor 101 generates memory operations that store data at the memory 115 (e.g., write operations), retrieve data from the memory 115 (e.g., read operations), or a combination thereof. Accordingly, in different embodiments the memory 115 includes random access memory (RAM), non-volatile memory (e.g., flash memory), storage devices such as hard disc drives and solid state disc drives, and the like, or any combination thereof. It will be appreciated that in some embodiments the processing system 100 includes additional memory not shown at FIG. 1, such as one or more caches, buffers, registers, and the like, and associated control circuitry.

The processing system 100 further includes a processor 101 generally configured to carry out processing operations, including one or more of general-purpose processing operations (e.g., execution of an operating system and application software), graphics processing operations, audio processing operations, display processing operations, machine learning and neural network operations, data security operations, and the like, or any combination thereof. To support execution of these operations, the processor 101 includes a plurality of processing engines, designated processing engines 102-107. Each of the processing engines 102-107 is generally configured to carry out processing operations of a designated type, or set of types, independently of the other processing engines. This allows the processor 101 to carry out multiple tasks at the different processing engines in parallel, thus improving processing efficiency.

To illustrate, in the example of FIG. 1 the processor 101 is assumed to be a multimedia processor generally configured to execute multimedia operations, including processing and presentation of audio data, image data, video data, and the like. Accordingly, each of the processing engines 102-107 is generally configured to carry out operations associated with one or more multimedia tasks. Thus, for the example of processing system 100, the processing engine 102 is a core complex including one or more processor cores that collectively form one or more central processing units (CPUs). The one or more CPUs are configured to execute (e.g., via one or more instruction pipelines) general-purpose processing tasks, such as execution of an operating system, user interface programs, productivity applications, and the like. The processing engine 103 is a graphics engine including one or more graphics processing units (GPUs) generally configured to execute graphics operations, such as draw operations, raytracing operations, image frame generation operations, and the like, or any combination thereof.

The processing engine 104 is an inference processing unit (IPU), also referred to as a neural processing unit (NPU), generally configured to execute machine learning operations, such as execution of operations associated with one or more machine learning models (MLMs). Thus, in some embodiments the NPU is configured to execute the operations associated with different layers of an MLM, including application of input data to an initial layer of the MLM, performing the calculations (e.g., matrix multiplications) for each layer of the MLM and based on the weights assigned to each layer, and generation of an output of the MLM at a final layer.

The processing engine 105 is a processing engine generally configured to execute display operations, including processing of pixel data and providing the pixel data to one or more display devices (not shown) to display. Examples of such display operations include one or more of color space conversion, linearization of pixel data, tone mapping, gamut mapping, plan blending, pixel formatting, display writeback, and the like, or any combination thereof. The processing engine 106 is a video codec processing engine and is generally configured to perform operations associated with one or more specified video codecs. Thus, for example, the processing engine 106 is configured to execute compression operations for video or audio data, decompression operations for video or audio data, and the like, or any combination thereof. The processing engine 107 is a video processing engine configured to execute video processing operations. Thus, for example, in some embodiments the processing engine 107 executes decoding operations, de-interlacing operations, gamma correction operations, scaling, filtering, and sharpening operations, encoding operations, quantization operations, discrete cosine transformation (DCT) and inverse DCT operations, motion compensation operations, blending operations, dithering operations, and the like, or any combination thereof.

It will be appreciated that the above-described processing engines are examples only, and that the techniques described herein apply to processors and processing systems having additional, fewer, or different processing engines than those illustrated in the example of FIG. 1. Further, although the different processing engines 102-107, and other circuits, are illustrated as being incorporated in a single processor 101, in other embodiments one or more of the processing engines is incorporated in a different processor, different integrated circuit, different chiplet, and the like, or any combination thereof.

The processing engines 102-107 are configured to communicate with each other via an interconnect 110. In different embodiments, the interconnect 110 is any fabric, or combination of fabrics, configured to route messages between different fabric ports. Thus, in different embodiments, the communication fabric is a Peripheral Component Interconnect Express (PCIe) fabric, an Infinity Fabric (IF), or other communication fabric. In operation, the processing engines 102-107 communicate with each other via messages referred to herein as transactions. Each transaction includes a request (e.g., a command) for a processing engine to perform one or more operations, results of operations executed by a processing engine, and the like, or any combination thereof. For example, in some embodiments, the processing engine 102 (the core complex) executes an application program. In the course of execution, the application generates one or more draw commands, and the processing engine 102 sends the draw commands, via one or more transactions, to the processing engine 103 (the graphics engine). The processing engine 103 executes the draw commands and provides the results of the draw operations, via one or more transactions, to, for example, the processing engine 105 (the display processor 105). In response, the processing engine 105 displays one or more frames for display at a display device.

In some embodiments, each transaction is associated with a memory address that indicates data targeted by the transaction. Accordingly, for each transaction generated by a processing engine, the processing engine also generates a corresponding virtual address. The processor 101 includes hypervisor 112 that is circuitry configured to manage the physical resources of the processor 101, including memory resources, for one or more executing programs (e.g., virtual machines). As part of the physical resource management, the hypervisor 112 is configured to set up page tables at a memory management unit (MMU) 114, wherein the page tables map virtual addresses to corresponding physical addresses, representing physical memory locations or other physical resources of the processing system 100. The MMU 114 is a circuit, such as a system memory management unit (SMMU) or input/output memory management unit (IOMMU), configured perform address translation for virtual addresses using the page tables set up by the hypervisor 112. Thus, for each transaction, the MMU 114 employs the page tables to convert the virtual address generated by the processing engine to a corresponding physical address.

The processor 101 further includes a memory controller 111 to support interaction with the memory 115 by the processing engines 102-107. In particular, the memory controller 111 includes circuits to receive memory access requests from the processing engines 102-107 via the interconnect 110, and to translate those memory access requests into control signaling. The memory controller 111 provides the control signaling to the memory 115 in order to carry out the memory access requests, and provides any responsive information (e.g., data read from the memory 115) to the processing engine that issued the memory access request.

In addition, the processor 101 includes a multimedia hub (MMHUB) 113 generally configured to manage multimedia and other operations for connected processing engines, such as the processing engine 107. Thus, for example, in some embodiments the MMHUB 113 aggregates transactions received from, and targeted to, the connected processing engines and other processors, and manages provision of those transactions to their targeted destinations. Accordingly, the MMHUB 113 includes circuits to perform aggregation operations such as transaction buffering, transaction flow management (e.g., backpressure, transaction priority management, and other management operations), and the like, or any combination thereof.

In some embodiments, the processor 101 is generally configured to store and process sensitive data—that is, data that is to be protected from unauthorized access. To support data security, the processor 101 includes a root-of-trust (RoT) processing unit 118. The RoT processing unit 118 is a processing unit that is isolated from access by the processing engines 102-107 and is generally configured to perform security operations for the processor 101. Examples of such security operations, in different embodiments, include: reception of cryptographic keys from a server (not shown) via a network, provision of the cryptographic keys to one or more of the processing engines 102-107 and the memory controller 111, management of a secure boot process for the processor 101, setting of security policies at the processor 101, handling of security interrupts at the processor 101, authentication and loading of firmware at the processing engines 102-107, managing software and hardware trust levels at the processor 101, and the like, or any combination thereof.

In some embodiments, the RoT processing unit 118 is configured to provision and manage security spaces, referred to as keyspaces, for the processor 101. Each keyspace corresponds to one or more security aspects of the processor 101, and the RoT processing unit 118 is configured to assign entities to the keyspaces, wherein the entities include one or more of the processing engines 102-107, one or more executing programs (e.g., one or more virtual machines), one or more DRM pipes, and the like, or any combination thereof. The security aspects of a keyspace, in different embodiments, include one or more of a cryptographic key, a key identifier (also referred to as a key ID) that indicates the cryptographic key, permission levels (e.g., permission to access a DRM pipe), read privileges (e.g., permission to read data), write privileges (e.g., permission to write data), and the like, or any combination thereof. Furthermore, each of the keyspaces is configurable by the RoT processing unit 118, allowing the processing unit 118 to configure the different keyspaces differently for different processing systems and processing system applications. Furthermore, in some embodiments, at least some of the keyspaces are managed, or managed in part, by an operating system executing at the processing engine 102, by a hypervisor (not shown), or a combination thereof.

To illustrate, in some embodiments the processor 101 employs keyspaces to govern access to different encrypted memory spaces, designated encrypted memory space 117 and encrypted memory space 119, at the memory 115. The RoT processing unit 118 provisions (e.g., from a trusted server) a different cryptographic key to each of two keyspaces and assigns each keyspace to a different one of the encrypted memory spaces 117 and 119. The RoT processing unit 118, an operating system, or the hypervisor 112, assigns each keyspace to a different program (e.g., a different virtual machine) executing at the processing engine 102. The memory controller 111 includes encryption/decryption circuits (not shown) to encrypt and decrypt data based on a cryptographic key. The RoT processing unit 118 provides the cryptographic key for each keyspace to the encryption/decryption circuits at the memory controller 111. In some embodiments, the encryption/decryption circuits store the provided keys in a table, and the entries of table are indexed by the associated key identifiers for the keys. When a program executing at the processing engine 102 generates a memory transaction (e.g., a read or write operation) targeting an encrypted memory space, the program provides with the memory transaction (e.g., via a memory address) a key identifier. The encryption/decryption circuit at the memory controller 111 uses the key identifier to identify a provided cryptographic key, such as by indexing the table of cryptographic keys, and uses the identified key to encrypt (for a write operation) or decrypt (for a read operation) the corresponding data. The processor 101 thus allows different programs executing at the processing engine 102 to employ protected (trusted) memory spaces to store sensitive data, and thereby protect the data from unauthorized access.

In some embodiments, the processor 101 employs keyspaces and a set of hardware gaskets (e.g., gaskets 109 and 116) to establish and enforce a set of hardware-isolated DRM pipes. As described further herein, each of the gaskets governs access to an ingress port of the interconnect 110 for a corresponding one of the processing engines 102-107. Thus, for example, the gasket 116 governs access to the interconnect 110 by the processing engine 102, while the gasket 109 governs access to the interconnect 110 by the processing engine 103. It will be appreciated that in the illustrated example of FIG. 1, the gaskets are located at the interconnect 110 itself (e.g., as part of the circuitry for each ingress port). However, in other embodiments the gaskets are located, for example, at each of the processing engines 102-107, at one or more hubs of the processor 101 (e.g. at the MMHUB 113), and the like.

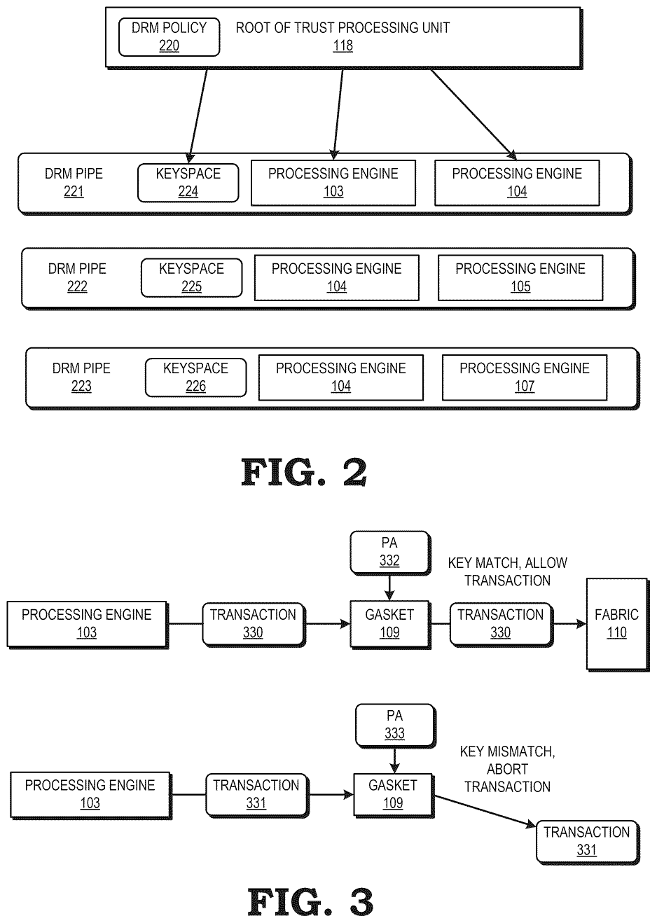

The RoT processing unit 118 is configured to establish a set of DRM pipes, with the set of DRM pipes governed by a DRM security policy that indicates a number of DRM pipes, which of the processing engines 102-107 are to be assigned to each DRM pipe, permission levels for each assigned processing engine (e.g., whether a processing engine has read permission, write permission, or both). An example is illustrated at FIG. 2 in accordance with some embodiments. In the illustrated example, the RoT processing unit 118 stores a DRM policy 220 that indicates the number of hardware-isolated DRM pipes to be established, and the characteristics of each DRM pipe, such as the processing engines assigned to each DRM pipe. In some embodiments, the DRM policy 220 is provided to the RoT processing unit during a provisioning process for the RoT processing unit 108, such as during manufacture or initial configuration of the processor 101 in a secure facility. In other embodiments, the RoT processing unit 118 accesses the DRM policy via a secure (e.g., cryptographically protected) communication session with a remote server (not shown).

In the example of FIG. 2, based on the DRM policy 220 the RoT processing unit 118 establishes three DRM pipes, designated DRM pipe 221, DRM pipe 222, and DRM pipe 223 respectively. The RoT processing unit 118 assigns, based on the DRM policy 220, one or more of the processing engines 102-107 to each of the DRM pipes 221-223. Thus, in the depicted example, the RoT processing unit 118 assigns processing engines 103 and 104 to the DRM pipe 221, assigns processing engines 104 and 105 to the DRM pipe 222, and processing engines 104 and 107 to the DRM pipe 223. Accordingly, and as illustrated by the example of FIG. 2, in some embodiments a processing engine is assigned to multiple DRM pipes, allowing applications associated with each of the multiple DRM pipes to access the corresponding processing engine. Furthermore, in some embodiments, a processing engine is not assigned to any DRM pipe. Thus, for example, in some embodiments the core complex at processing engine 102 is not assigned to any DRM pipe, thus preventing an operating system or other program from accessing the secure data associated with the DRM pipes.

The RoT processing unit 118 assigns a different keyspace to each of the DRM pipes 221-223. In the illustrated example, the RoT processing unit 118 assigns keyspace 224 to DRM pipe 221, keyspace 225 to DRM pipe 222, and keyspace 226 to DRM pipe 223. The RoT processing unit 118 assigns a different key, and corresponding key ID, to each keyspace and provides the key IDs for each DRM pipe to the gaskets of the interconnect 110, and also provides each of the processing engines 102-107 the key IDs for the corresponding DRM pipes assigned to the processing engine. Thus, for example, the RoT processing unit provides the key ID for keyspace 225 to the processing engines 105 and 105, and the key ID for keyspace 226 to the processing engines 104 and 107.

The gaskets (e.g., gaskets 109 and 116) are configured to employ the provided key IDs to prevent unauthorized transactions (that is, transactions from a processing engine that target a DRM pipe not assigned to the processing engine, or transactions associated with an improper physical address) from being communicated by the interconnect 110. An example is illustrated at FIG. 3 in accordance with some embodiments.

In the example of FIG. 3, the processing engine 103 provides two transactions, designated transaction 330 and transaction 331, respectively to the gasket 109. Each of the transactions 330 and 331 include a key ID, indicating the key for the DRM pipe targeted by the transaction, and a transaction payload, indicating a request to, for example, read or write data. In addition, for each transaction the MMU 114 provides the physical address corresponding to the transaction (based on translating a virtual address provided by the processing engine 103). The RoT processing unit 118 has generated the key IDs for the processing engine 103 such that a proper address translation (that is, an address translation carried out in a specified way by an authorized hypervisor and MMU) results in a portion of the physical address matching the key ID for the corresponding transaction. In other words, in some embodiments an authorized transaction by a processing engine includes at least two features: 1) a key ID provided with the transaction that matches a key ID for the DRM pipe associated with the transaction; and 2) a physical address for the transaction wherein a specified portion of the physical address matches the key ID for the DRM pipe associated with the transaction. The gaskets are configured to discard transactions that do not have both of these features. This approach improves security by reducing the Trusted Computing Base (TCB) for the different DRM pipes. In some embodiments, the TCB for the DRM pipes is such that the page tables and virtual-to-physical address translation are trusted. In at least some of these embodiments, the comparison of the key ID to the physical address is omitted.

The gasket 109 includes circuits configured to compare, for each transaction, the indicated key ID, and specified portion of the corresponding physical address, to the key IDs assigned to the corresponding processing engine. In response to a match, the gasket 109 provides the transaction to the interconnect 110. In response to a mismatch (that is, in response to the transaction key ID not matching a key ID assigned to the corresponding processing engine or to the specified portion of the physical address not matching the key ID assigned to the processing engine), the gasket 109 discards the transaction, such that the transaction is not routed to its targeted destination.

Thus, in the example of FIG. 3, the gasket 109 determines that the key ID indicated by transaction 330 matches a key ID assigned to the processing engine 103. The gasket 109 further determines that a specified portion of a physical address 332, provided by the MMU 114, matches the key ID indicated by transaction 330. In response to the two matches, the gasket 109 provides the transaction 330 to an ingress port of the interconnect 110, which routes the transaction 330 to its targeted destination for further processing. In contrast, the gasket 109 determines that the key ID indicated by transaction 331 does not match a key ID assigned to the processing engine 103, or that a specified portion of a physical address 333 does not match they key ID indicated by the transaction 331. These mismatches indicate that the transaction 331 may be an unauthorized attempt to access a DRM pipe, or that an improper physical address for the transaction has been provided (possibly indicating a malicious hypervisor has set up unauthorized page tables at the MMU 114). The gasket 109 therefore discards the transaction 331. That is, the gasket 109 does not provide the transaction 331 to an ingress port of the interconnect 110, so that the transaction 331 is prevented from reaching its targeted destination. In some embodiments, the gasket 109 takes additional action, such as notifying (e.g., via an interrupt) the RoT processing unit 118 of the unauthorized transaction. In response, the RoT processing unit takes remedial action, such as terminating execution of one or more programs, notifying a user or remote server of the unauthorized transaction, and the like, or any combination thereof.

Thus, as illustrated by the example of FIG. 3, the gaskets of the processor 101 enforce the security of the DRM pipes 221-223 by only allowing communication of authorized transactions, where the authorization of transactions is governed by the keyspaces, and associated keys, assigned by the RoT processing unit 118. The gaskets thus provide hardware enforcement of secure DRM pipes. In particular, the gaskets are not accessible by, for example, programs executing at the processing engine 102 (the core complex), thus protecting the configuration of the DRM pipes from unauthorized manipulation by executing software. In some embodiments, the gaskets are also not accessible by the hypervisor 112 of the processing system 100, further protecting the security of the DRM pipes.

In some embodiments, the DRM policy 220 indicates additional security aspects for each processing engine and DRM pipe, and the gaskets of the processor 101 enforces these additional security aspects. For example, in some embodiments the DRM policy 220 indicates, for each processing engine assigned to a DRM pipe, the transaction types that are permitted for the processing engine, including whether read transactions, write transactions, or both, are permitted for the processing engine. The RoT processing unit 118 distributes to each of the gaskets of the processor 101, the transaction types permitted for each processing engine and corresponding DRM pipe. In response to receiving a transaction, in addition to checking the transaction key as explained above, the gasket identifies (e.g., based on a field of the transaction) the transaction type. In response to determining that the transaction type is not permitted for the processing engine, the gasket discards the transaction. Thus, for example, in response to receiving a write transaction for DRM pipe 221 from the processing engine 103, the gasket 109 determines, based on the transaction key, that the processing engine 103 is permitted to access the DRM pipe 221. However, the gasket 109 further determines that the processing engine 103 only has read permission for the DRM pipe 221, and that write transactions for DRM pipe 221 by the processing engine 103 are not permitted. In response, the gasket 109 discards the transaction, and does not permit the transaction to be provided to the interconnect 110.

As another example, in some embodiments the DRM policy 220 indicates, for each processing engine assigned to a DRM pipe, one or more client identifiers for clients (e.g., applications) that are permitted for the processing engine. The RoT processing unit 118 distributes to each of the gaskets of the processor 101, the client identifiers permitted for each processing engine and corresponding DRM pipe. In response to receiving a transaction, in addition to checking the transaction key (and, optionally, the transaction type) as explained above, the gasket identifies (e.g., based on a field of the transaction) the client identifier for the transaction. In response to determining that the client identifier is not permitted for the processing engine, the gasket discards the transaction. This allows the processing system 100 to allow individual applications, virtual machines, or other clients selective access to the different DRM pipes.

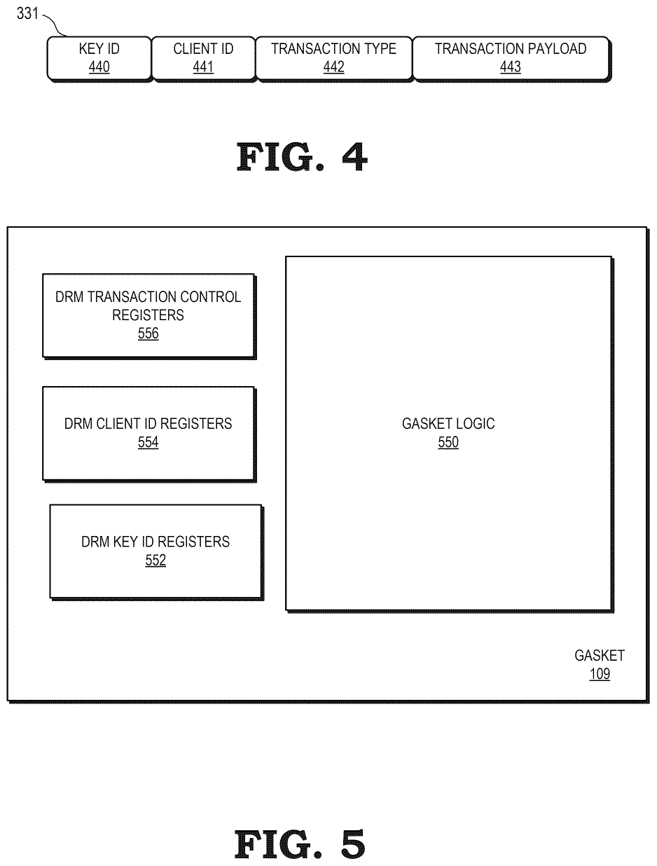

FIG. 4 illustrates an example of the transaction 331 in accordance with some embodiments. In the illustrated example, the transaction 331 includes a plurality of fields, including a key ID field 440, a client ID field 441, a transaction type 442, and a transaction payload 443. The key ID field 440 stores the key identifier for the transaction, while the client ID field stores the client identifier for the transaction. The transaction type field 442 stores an indicator of the type of transaction, such as whether the transaction 331 is a read transaction (a transaction to read data), a write transaction (a transaction to store data), or other type of transaction. The transaction payload field 443 stores payload data for the transaction 331, such as data to be stored (for a write transaction), address data, control data, and the like, or a combination thereof. In some embodiments, one or more of the key ID field 440, client ID field 441, and transaction type field 442 correspond to a portion of a memory address associated with the transaction 331. For example, in some embodiments the key ID field 440 is a portion of a physical memory address targeted by the transaction. Furthermore, in some embodiments the key ID field is provided as a hardware signal separate from firmware executed by the corresponding processing engine. Each of the gaskets of the processor 101 is configured to employ the fields of each received transaction (such as transaction 331) to determine whether to provide the transaction to the interconnect 110, as described further herein.

FIG. 5 illustrates a block diagram of the gasket 109 in accordance with some embodiments. In the depicted example, the gasket 109 includes gasket logic 550, DRM key registers 552, DRM client identifier (ID) registers 554, and DRM transaction control registers 556. The DRM key registers 552 are a set of registers configured to store the DRM pipe keys assigned to each of the processing engines 102-107. The DRM client ID registers 554 are a set of registers configured to store the client identifiers assigned to the processing engine 103. The DRM transaction control registers 556 are a set of registers configured to store the transaction types (e.g., read or write transactions) assigned to the processing engine 103. Thus, for example, in some embodiments the DRM client ID registers 554 include a different register for each of the processing engines 102-107, and each of the different registers stores the transaction types permitted for the corresponding processing engine.

In some embodiments, the DRM key registers 552, the DRM client ID registers 554, and the DRM transaction control registers 556 are populated (that is, data is stored at the registers) by the RoT processing unit 118 during a boot process for the processor 101. Thus, for example, during the boot process the RoT processing unit identifies, based on the DRM policy 220, the keyspaces, key IDs, transaction types, and client identifiers for the processing engine 103 and stores the corresponding information at the DRM key registers 552, the DRM client ID registers 554, and the DRM transaction control registers 556. The RoT processing unit stores similar information at each of the gaskets of the processor 101 for the corresponding processing engine.

The gasket logic 550 is a circuit configured to receive transactions from a processing engine (e.g., processing engine 103), compare the fields of each received transaction to the corresponding information at the DRM key ID registers 552, the DRM client ID registers 554, and the DRM transaction control registers 556 and, based on the comparison, either provide the transaction to the interconnect 110 for routing to the transaction's destination, or discard the transaction. Thus, for example, if the transaction key ID field, or a specified portion of the physical address supplied by the MMU 114, does not match a key ID stored at the DRM key ID registers 552, the gasket logic 550 discards the transaction. Similarly, if the client ID field of the transaction does not match a client identifier stored at the client ID registers 554. In addition, if the transaction type field of the transaction does not match a transaction type assigned stored at the DRM transaction control registers 556, the gasket logic 550 discards the transaction. Otherwise (that is, if there is a match with each field of the transaction to data at the corresponding set of registers), the gasket logic 550 provides the transaction to the interconnect 110. In some embodiments, the gasket logic 550 is configured to receive for a received transaction, a corresponding physical address from the MMU 114 (representing the translation of a virtual address generated by the processing engine to the physical address). The gasket logic 550 is configured to compare a specified portion (e.g. a specified subset of bits) of the received physical address to the key ID of the transaction. In response to a mismatch, the gasket logic 550 discards the transaction.

It will be appreciated that while in the example of the processing system 100 the gaskets (e.g., the gasket 109) are illustrated as separate hardware located at the interconnect 110, in some embodiments one or more aspects of the gaskets are executed by circuitry at the corresponding processing engine. For example, in some embodiments each processing engine includes hardware to compare the key ID for a generated transaction to a portion of a received physical address, and to a set of assigned key IDs provided by the RoT processing unit 118. In response to either of these comparisons indicating a mismatch, the processing engine discards the transaction (that is, does not provide the transaction to the interconnect 110). In response to both comparisons indicating a match, the processing engine provides the transaction to the interconnect 110.

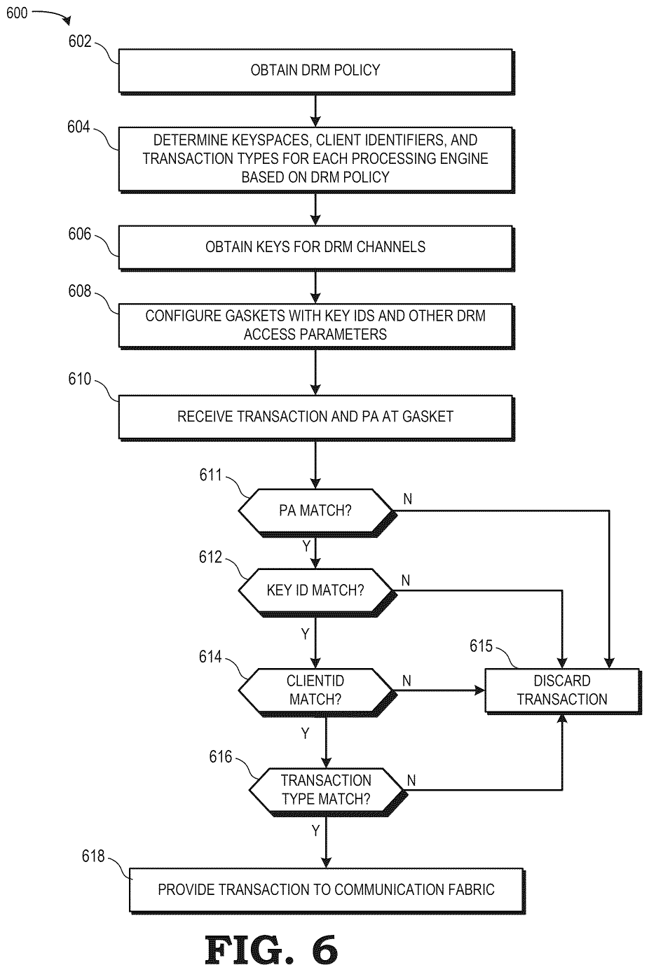

FIG. 6 is a flow diagram of a method 600 of employing a hardware gasket at a processing system to establish secure DRM pipes in accordance with some embodiments. For purposes of description, the method 600 is described with respect to an example implementation at the processing system 100 of FIG. 1, but it will be appreciated that in other embodiments the method 600 is implemented at processing systems having a different configuration. At block 602, the RoT processing unit 118 obtains the DRM policy 220. In some embodiments, the RoT processing unit 118 receives the DRM policy 220 via a secure (e.g., cryptographically protected) communication session with a remote server. In other embodiments, the DRM policy 220 is stored at the RoT processing unit 118 during a provisioning process for the processing system 100, such as being stored when the processor 101 or the processing system 100 is configured in a secure facility.

At block 604, the RoT processing unit 118 employs the DRM policy 220 to determine the number of DRM pipes, the keyspace to be assigned to each of the DRM pipes, and how each DRM pipe is to be configured. In particular, the RoT processing unit determines which of the processing engines 102-107 is to be permitted access to each of the DRM pipes, which clients (e.g., applications, processes, and the like) at each of the processing engines 102-107 is to be permitted access to each of the DRM pipes, and what transaction types (e.g., read operations, write operations, or both) each of the processing engines 102-107 is permitted to execute for each of the DRM pipes.

At block 606, the RoT processing unit 118 identifies the key, and corresponding key ID, for each keyspace assigned to the different DRM pipes. In some embodiments, the RoT processing unit 118 obtains the keys via a secure (e.g., cryptographically protected) communication session with a remote server.

At block 608, the RoT processing unit 118 stores information at the registers of each gasket (e.g., the gaskets 109 and 116) to configure each gasket, and corresponding processing engine according to the DRM policy 220, and using the keys and other information determined at block 604. Thus, for example, for the DRM pipes to which the processing engine 103 is permitted access (as indicated by the DRM policy 220), the RoT processing unit 118 stores, at the registers of the gasket 109, the corresponding key IDs, client identifiers, and transaction types. The RoT processing unit 118 configures the other gaskets in similar fashion, with the corresponding key IDs, client identifiers, and transaction types for each of the processing engines 102-107.

At block 610, a gasket of the processor 101 receives a transaction from the corresponding processing engine and receives a physical address for the transaction from the MMU 114. For purposes of description, it is assumed that the gasket 109 receives a transaction from the processing engine 103. In response, at block 611, the gasket 109 compares a specified portion of the received physical address to the key ID field of the transaction (e.g., key field 440 of transaction 331). If the key ID field does not match the specified portion of the physical address, the method flow moves to block 615 and the gasket 109 discards the transaction. In some embodiments, the MMU 114 and generation of the physical address are within the TCB of the processing system 100. That is, the physical address is generated in a specified way such that the address is a trusted value. In at least some of these embodiments, block 610 is omitted, and the physical address is not checked for each transaction.

If, at block 611, the portion of the physical address matches the key ID field of the transaction, the method flow moves to block 612 and the control logic 550 compares the key ID field to the key IDs stored at the DRM key registers 552. If the key ID field does not match (that is, the transaction does not include a key ID for a DRM pipe assigned to the processing engine 103), the method flow moves to block 615 and the gasket 109 discards the transaction.

If, at block 612, the gasket logic 550 determines that the DRM key registers 552 do include a match to the transaction key, the method flow moves to block 614, and the gasket logic 550 compares the client ID field of the transaction (e.g., the client ID field 441) to the client identifiers stored at the DRM client ID registers 554. If there is not a match (that is, the transaction does not include a client identifier assigned to the processing engine 103), the method flow moves to block 615 and the gasket 109 discards the transaction.

If, at block 614, the gasket logic 550 determines that the DRM client ID registers do include a match to the transaction client ID, the method flow moves to block 616, and the gasket logic 550 compares the transaction type field of the transaction (e.g., the transaction type field 442) to the transaction types stored at the DRM transaction control registers 556. If there is not a match (that is, the transaction is not a transaction type assigned to the processing engine 103), the method flow moves to block 615 and the gasket 109 discards the transaction. If there is a match, the method flow moves to block 618 and the gasket 109 provides the transaction to the interconnect 110.

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
receiving, at a first hardware security gasket of a processor, a first transaction targeting a first digital rights management (DRM) pipeline; and
allowing the first transaction to proceed at the first hardware security gasket based on a first keyspace identified by the first transaction and a second keyspace assigned to the first DRM.

2. The method of claim 1, wherein allowing the first transaction to proceed comprises providing the first transaction to an interconnect of the processor.

3. The method of claim 1, further comprising:
allowing the first transaction to proceed further based on a security policy assigned to the first DRM.

4. The method of claim 3, wherein the security policy indicates a transaction type, and allowing the first transaction comprises allowing the first transaction in response to identifying the first transaction as matching the transaction type.

5. The method of claim 4, wherein the transaction type includes at least one of a read transaction and a write transaction.

6. The method of claim 1, further comprising:
allowing the first transaction to proceed further based on a client identifier indicated by the first transaction.

7. The method of claim 1, further comprising:
discarding the first transaction based on a mismatch between the first keyspace and a portion of a received physical address associated with the first transaction.

8. The method of claim 1, further comprising:
receiving, at the first hardware security gasket, a second transaction targeting a second DRM pipe; and
allowing the second transaction to proceed at the first hardware security gasket based on a third keyspace identified by the second transaction and a fourth keyspace assigned to the second DRM pipe.

9. The method of claim 1 further comprising omitting comparison of the first keyspace to a portion of a physical address in response to the physical address being within a trusted computing base (TCB) of the processor.

10. A processor comprising:
a first processing engine to generate a first transaction targeting a first digital rights management (DRM) pipeline; and
a security gasket configured to allow the first transaction to proceed based on a first keyspace identified by the first transaction and a second keyspace assigned to the first DRM.

11. The processor of claim 10, further comprising:
an interconnect; and
wherein the security gasket is configured to allow the first transaction to proceed by providing the first transaction to the interconnect.

12. The processor of claim 10, wherein the security gasket is configured to:
allow the first transaction to proceed further based on a security policy assigned to the first DRM.

13. The processor of claim 12, wherein the security policy indicates a transaction type, and allowing the first transaction comprises allowing the first transaction in response to identifying the first transaction as matching the transaction type.

14. The processor of claim 13, wherein the transaction type includes at least one of a read transaction and a write transaction.

15. The processor of claim 14 wherein the security gasket is configured to:
allow the first transaction to proceed further based on a client identifier indicated by the first transaction.

16. The processor of claim 10, wherein:
the security gasket is configured to discard the first transaction based on a mismatch between the first keyspace and a portion of a received physical address associated with the first transaction.

17. The processor of claim 10, wherein the security gasket is configured to:
receive a second transaction targeting a second DRM pipe; and
allow the second transaction to proceed based on a third keyspace identified by the second transaction and a fourth keyspace assigned to the second DRM pipe.

18. The processor of claim 17, further comprising a second processing engine to generate the second transaction.

19. A processing system comprising:
a processor including:
a first processing engine to generate a first transaction targeting a first digital rights management (DRM) pipeline; and
a security gasket configured to allow the first transaction to proceed based on a first keyspace identified by the first transaction and a second keyspace assigned to the first DRM; and
a memory to store data for the DRM pipe based upon a third keyspace.

20. The processing system of claim 19, wherein the processor further comprises:
a interconnect; and
wherein the security gasket is configured to allow the first transaction to proceed by providing the first transaction to the interconnect.
